(19) United States
(12) Patent Application Publication
(10) Pub. No.: US 2025/0158236 A1
(43) Pub. Date: May 15, 2025

(54) BATTERY PACK BUSBAR SHIELD

(71) Applicant: Ford Global Technologies, LLC, Dearborn, MI (US)

(72) Inventors: Di Zhu, Novi, MI (US); Bhaskara Rao Boddakayala, Troy, MI (US); Bin Yin, Nanjing (CN); Steven Shi, Dearborn, MI (US)

(21) Appl. No.: 18/822,590

(22) Filed: Sep. 3, 2024

Related U.S. Application Data
(60) Provisional application No. 63/599,186, filed on Nov. 15, 2023.

(51) Int. Cl. H01M 50/507; H01M 50/249; H01M 50/375; H01M 50/521

(52) U.S. Cl. CPC H01M 50/507; H01M 50/249; H01M 50/375; H01M 50/521

(57) ABSTRACT

A battery pack assembly includes an enclosure assembly that provides an interior area. Battery cells are within the interior area. The battery cells each include at least one tab terminal that projects outward from the array axis. A frame provides at least one slot that receives a portion of the at least one tab terminal. At least one busbar is secured to the frame. A busbar shield is disposed between at least one cell and at least one busbar within a battery pack.

### CROSS-REFERENCE TO RELATED APPLICATIONS

This application claims the benefit of U.S. Provisional Application No. 63/599,186, which was filed on 15 Nov. 2023 and is incorporated herein by reference.

### TECHNICAL FIELD

This disclosure relates generally to a shield used within a battery pack and, more particularly, to a shield that blocks movement of vent byproducts toward busbars.

### BACKGROUND

A high voltage traction battery pack can power the electric machines and other electrical loads of an electrified vehicle. The traction battery pack can include a plurality of individual battery cells. The traction battery pack can, from time to time, experience a thermal event where one or more of the battery cells vent and expel battery vent byproducts. The vent byproducts can include gases and effluent particles.

### SUMMARY

In some aspects, the techniques described herein relate to a battery pack assembly, including: an enclosure assembly that provides an interior area; a plurality of battery cells disposed along a array axis and disposed within the interior area; each of the plurality of battery cells including at least one tab terminal that projects outward from the array axis; a frame providing at least one slot that receives a portion of the at least one tab terminal; at least one busbar secured to the frame; and a busbar shield between at least one cell and at least one busbar within a battery pack.

In some aspects, the techniques described herein relate to a battery pack assembly, wherein the frame is between the at least one busbar and the busbar shield.

In some aspects, the techniques described herein relate to a battery pack assembly, wherein the busbar shield is secured directly to the frame.

In some aspects, the techniques described herein relate to a battery pack assembly, wherein the busbar shield includes a plurality of fingers.

In some aspects, the techniques described herein relate to a battery pack assembly, wherein the plurality of fingers are a plurality of tapered fingers.

In some aspects, the techniques described herein relate to a battery pack assembly, wherein the at least one tab terminal extends between the plurality of fingers.

In some aspects, the techniques described herein relate to a battery pack assembly, wherein the busbar shield includes three fingers.

In some aspects, the techniques described herein relate to a battery pack assembly, wherein the busbar shield is ceramic wool, mica, fiberglass, or some combination of these.

In some aspects, the techniques described herein relate to a battery pack assembly, wherein the busbar shield is provided by a sheet of material having at least one shield slot, the at least one tab terminal extending through the shield slot.

In some aspects, the techniques described herein relate to a battery pack assembly, wherein the at least one tab terminal is secured to the at least one busbar.

In some aspects, the techniques described herein relate to a battery pack assembly, further including a container assembly that holds a mixture of agents, the container assembly configured to release the mixture of agents in response to a thermal event proximate the container assembly, the container assembly disposed between plurality of battery cells and the frame.

In some aspects, the techniques described herein relate to a battery pack assembly, wherein the busbar shield is secured directly to the container assembly.

In some aspects, the techniques described herein relate to a battery pack assembly, wherein the busbar shield is configured to wrap around the container assembly during installation of the container assembly within the battery pack.

In some aspects, the techniques described herein relate to a battery pack assembly, wherein the busbar shield is between the container assembly and the frame.

In some aspects, the techniques described herein relate to a battery pack assembly, wherein the agents are configured, when released from the container assembly, to electrically isolate, block a transfer of thermal energy, or both.

In some aspects, the techniques described herein relate to a battery pack assembly, wherein the mixture of agents includes sodium silicate.

In some aspects, the techniques described herein relate to an battery pack assembly, including: an enclosure assembly that provides an interior area; a plurality of battery cells disposed along a array axis and disposed within the interior area, each of the plurality of battery cells including at least one tab terminal that projects outward from the array axis; a busbar module having a frame and a plurality of busbars mounted to the frame; a plurality of container assemblies disposed alongside the plurality of battery cells between the busbar module and the plurality of battery cells, each holding a mixture of agents, the container assembly configured to release the mixture of agents in response to a thermal event proximate the container assembly, the plurality of container assemblies; and one or more busbar shields disposed alongside the plurality of container assemblies between the busbar module and the plurality of battery cells, the at least one tab terminal extending between the plurality of container assembles, through a slot the busbar shield, and through a slot in the frame to connect to at least one of the busbars within the plurality of busbars.

In some aspects, the techniques described herein relate to a battery pack assembly, wherein the busbar shields are between the plurality of container assemblies and the frame.

In some aspects, the techniques described herein relate to a battery pack assembly, wherein the busbar shields are secured to the frame.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a schematic, top view of a portion of a battery array of the battery pack of FIG. 2 and shows how container assemblies and busbar shields could be incorporated into a battery pack.

FIG. 4 illustrates an example container assembly that can release a mixture of agents.

FIG. 5 illustrates a section view taken at line 5-5 in FIG. 4.

FIG. 6 illustrates a top, perspective view of a busbar module from the battery pack of FIG. 2.

FIG. 7 illustrates a portion of the busbar module of FIG. 6.

### DETAILED DESCRIPTION

A battery pack can include busbars. During a thermal event, thermal energy and particulates can reach the busbars. The battery pack can include at least one container assembly that can release a mixture of agents during the thermal event. The released agents help to suppress the thermal events from cascading through the battery pack. This disclosure is directed toward includes a busbar shield that blocks thermal energy and particulars from reaching the busbars.

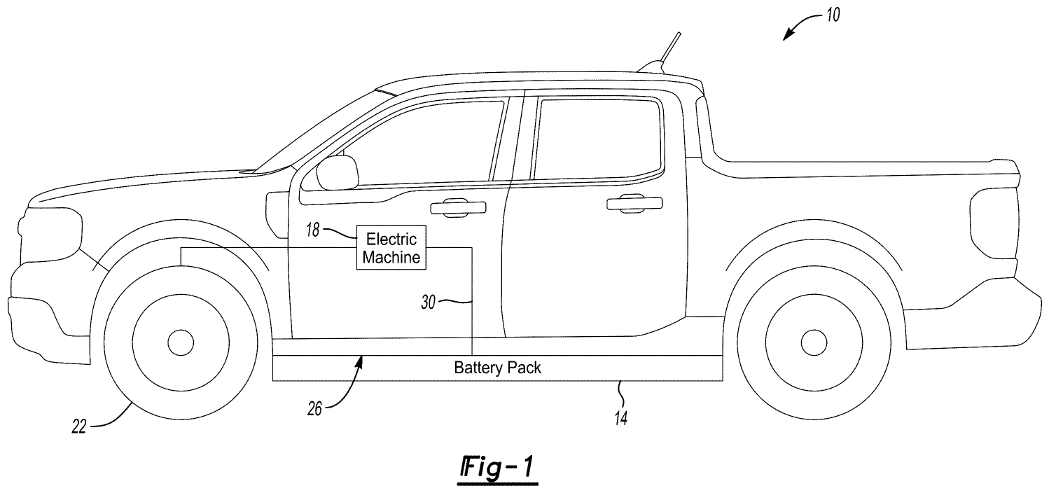

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples. A voltage bus 30 electrically couples the electric machine 18 to the traction battery pack 14.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

In the illustrated embodiment, the electrified vehicle 10 is a full electric vehicle propelled solely through electric power, such as by one or more electric machines 18, without assistance from an internal combustion engine. The electric machine 18 may operate as an electric motor, an electric generator, or both. The electric machine 18 receives electrical power and can convert the electrical power to torque for driving one or more wheels 22 of the electrified vehicle 10.

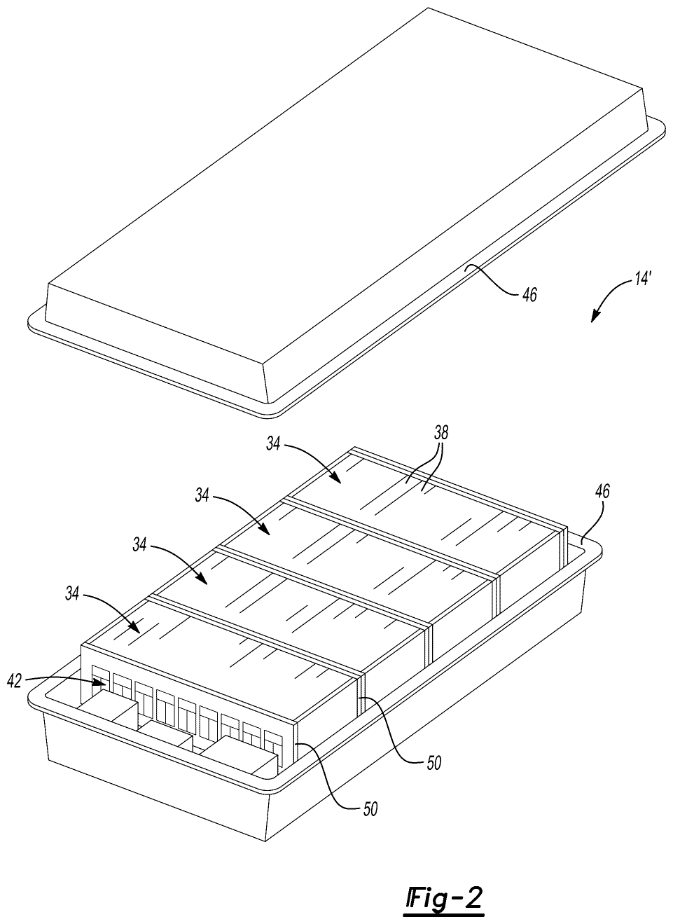

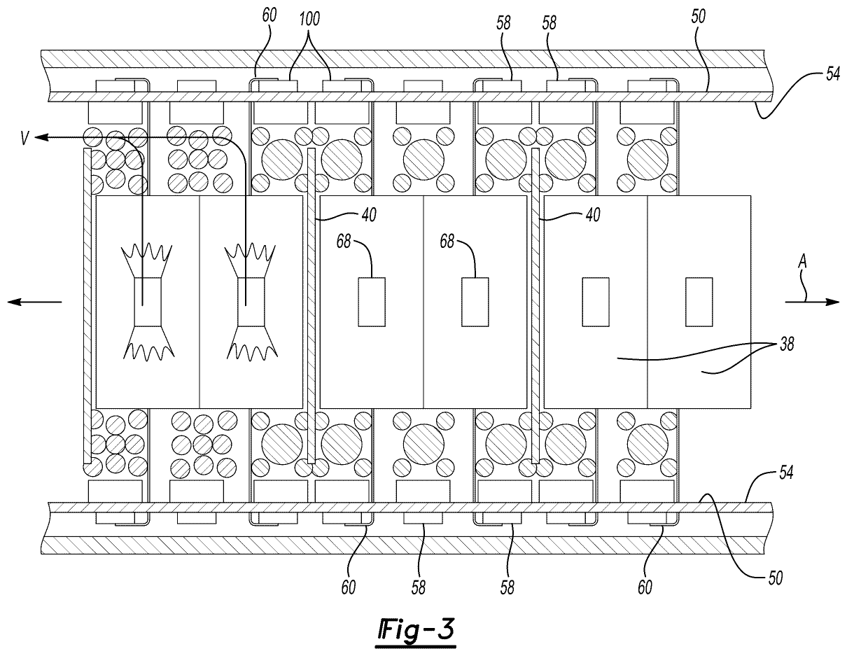

With reference to FIGS. 2 and 3 and continued reference to FIG. 1, the example traction battery pack 14 includes battery arrays 34 capable of outputting electrical power to power the electric machine 18 and/or other electrical loads of the electrified vehicle 10. Other types of energy storage devices and/or output devices could alternatively or additionally be used to electrically power the electrified vehicle 10.

The one or more battery arrays 34 of the traction battery pack 14 each include a plurality of battery cells 38 that store energy for powering various electrical loads of the electrified vehicle 10. Each of the battery arrays 34 includes, among other things, battery cells 38 (or simply “cells”) stacked side-by-side relative to each along a respective battery array axis. The battery cells 38 store and supply electrical power. Within each of the battery arrays 34, groups of one or more of the cells 38 can be separated from each other by a thermal barrier 40.

Although a specific number of the battery arrays 34 and cells 38 are illustrated in the various figures of this disclosure, the battery pack 14 could include any number of the battery arrays 34 each having any number of individual cells 38.

The traction battery pack 14 could employ any number of battery cells 38 within the scope of this disclosure. Accordingly, this disclosure should not be limited to the configuration shown in FIGS. 2 and 3.

In an embodiment, the battery cells 38 of each battery array 34 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 34 and various other battery internal components (e.g., bussed electrical center, battery electric control module, wiring, connectors, etc.) may be housed within an interior area 42 of an enclosure assembly 46. The enclosure assembly 46 may include an enclosure cover and an enclosure tray, for example. The enclosure cover may be secured (c.g., bolted, welded, adhered, etc.) to the enclosure tray to provide the interior area 42. The size, shape, and overall configuration of the enclosure assembly 46 is not intended to limit this disclosure.

Within the interior area 42, the battery arrays 34 are each positioned between a pair of busbar modules 50, which each have a frame 54 and plurality of individual busbars 58 mounted to the frame 54. Tab terminals 60 of the battery cells 38 project outward from the battery array axis extend through slots in the frame 54 and are folded over the busbars 58. The busbars 58 and tab terminals 60 can be connected together via welds.

During a thermal event, one or more of the battery cells 38 may periodically release vent byproducts V (FIG. 3) through a vent 68. The vent byproducts V can include gas and particulate matter. This disclosure is primarily directed to shielding area of the battery pack 14 from the vent byproducts V, particularly the busbars 58.

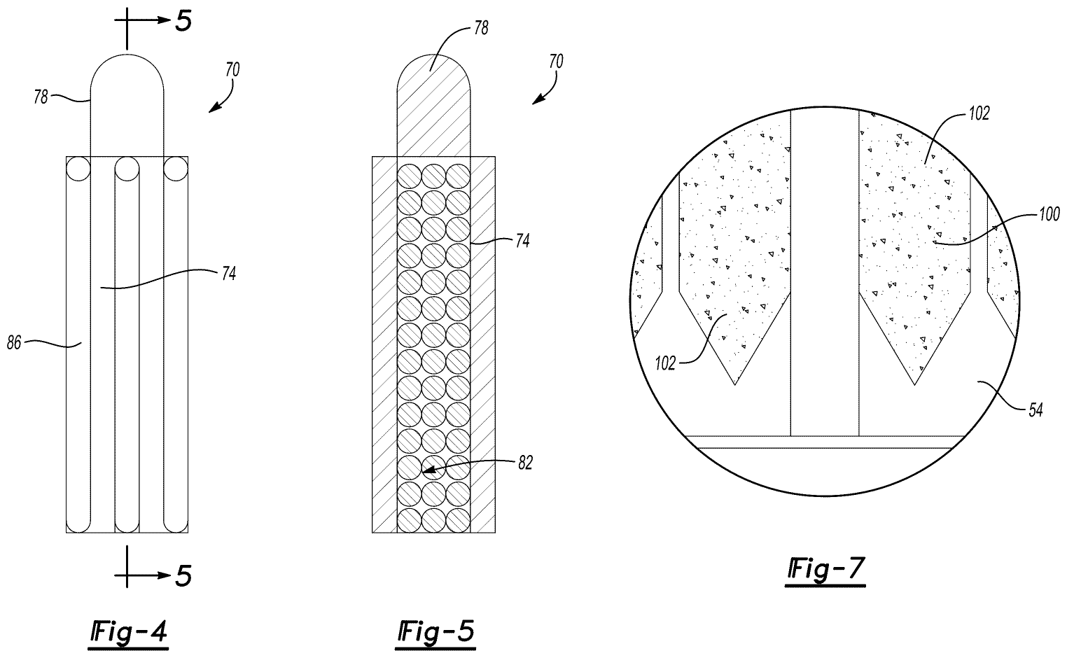

Referring now to FIGS. 3-5 with continuing reference to FIGS. 1 and 2, the example battery arrays 34 includes a thermal suppression system for managing the transfer of thermal energy across the battery arrays 34. The example thermal suppression system includes a plurality of container assemblies 70 that can be strategically positioned within the battery array 34 for managing the transfer of thermal energy during venting events. For example, among other benefits, the container assemblies 70 may be configured to mitigate the cell-to-cell and/or array-to-array transfer of thermal energy when one or more of the battery cells 38 within the battery arrays 34 release vent byproducts V.

Each container assembly 70, in this example, include a housing 74, a cap 78, and a mixture of agents 82 contained within the housing 74 by the cap 78. The container assemblies 70 of the thermal suppression system can be arranged within a void space located within the battery array 34.

In an embodiment, at least some of the container assemblies 70 are positioned between cell tab terminals 60 of adjacent battery cells 38, or between the cell tab terminal 60 of one of the battery cells 38 and one of the thermal barriers 40 of the battery array 34. However, other arrangements are contemplated within the scope of this disclosure, and it should be understood that the container assemblies 70 could be arranged within any void space within the battery array 34 or battery pack 14 where it is desirable to limit the transfer of thermal energy.

In some examples, the container assemblies 70 could be integrated within another component of the battery pack 14. For example, the frame 54 of the bus bar module could be formed to include a plurality of pockets that provide the container assemblies 70. The mixture of agents 82 can be contained within an interior volume provided by each of the pockets. The cap 78 can be integrated into the frame 54 to hold the hold the mixture of agents within the pockets.

The housing 74 may include any shape (c.g., cylindrical, rectangular, spherical, etc.) and may be made of a suitable polymeric material (c.g., polypropylene, polyethylene, silicone, TPV, acrylic, or some combination of these). In the example embodiment, the housing 74 includes support feet 86 that aid in positioning and securing the container assembly 70 within the desired void space (e.g., between adjacent cell tab terminals 60) of the battery array 34. In other examples, the housing 74 does not include support feet 86.

The cap 78 may include any shape (e.g., oval, long oval, trapezoidal, etc.) and may be made from either the same material or a different material than the housing 74. The cap 78 may be made of polypropylene, silicone, ethylene propylene diene monomer (EPDM) rubber, thermoplastic elastomer (TPE), etc.

The mixture of agents 82 is, in this example, is held within a hollow interior volume established by the housing 74. The mixture of agents 82 may be made of a high temperature material such as solid silica, aerogel, mica, basalt, etc. The mixture of agents 82 can be provided in bead, particulate, and/or powder form, for example.

The plurality of container assembles 70 are each configured to release the mixture of agents 82 in response to a thermal event that is proximate that container assembly 70. The housing 74, the cap 78, or both may be designed to melt, rupture or otherwise deform to release the mixture of agents 82 when exposed to temperatures that exceed a predefined temperature threshold (e.g., between 150 and 250 degrees Celsius). Such temperatures may be present, for example, when one or more battery cells 38 near the container assembly 70 experiences a thermal event and is venting the vent byproducts V. Once released, the mixture of agents 82 may capture or trap particles associated with the vent byproducts V, thereby managing or even preventing the transfer of thermal energy toward the non-venting battery cells 38 of the battery array. The non-ruptured container assemblies 70 may also reduce movement of the vent byproducts V toward the non-venting battery cells 38 of the battery array 34.

The mixture of agents 82 that are released can include endothermic materials and materials that help to electrically isolate. Example materials can include sodium silicate, a ceramic- based compound, melamine poly (zinc phosphate), aluminum tri-hydrate, and silicon dioxide. Other potential agents included within the mixture of agents 82 could include silica, mica, basalt, aerogels, etc.

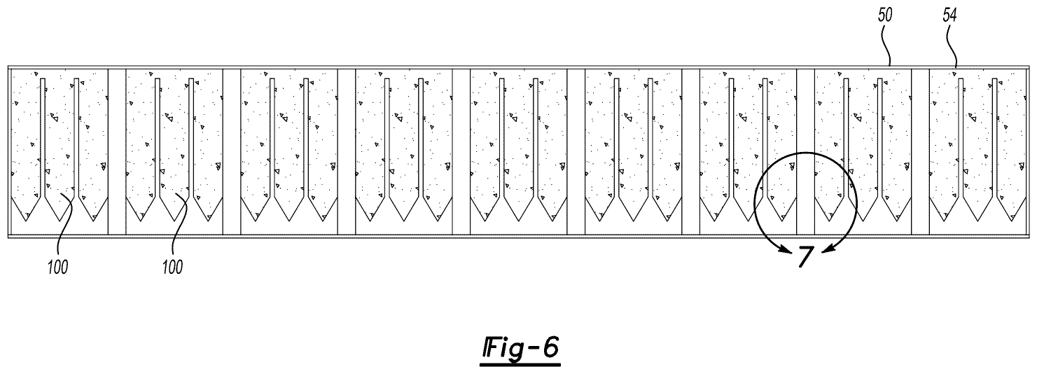

With reference now to FIGS. 6 and 7 and continuing reference to FIG. 3, another feature of the example thermal suppression system includes busbar shields 100, which are disposed outboard the container assemblies 70 and inboard the busbars 58. The busbar shields 100 are thus disposed between the busbars 58 and the cells 38. The example busbars 58 are outboard the associated frames 54. In another example, the frame 54 could be outboard of the busbars 58.

During a thermal event, the mixture of agents 82 can block and trap particulate matter within the vent byproducts V from moving outboard to the busbars 58 and from moving along the axis A toward other cells 38. The particulate matter can include conductive particles. Blocking the conductive particles from contacting or being directly adjacent the busbars 58 can help to prevent the conductive particles becoming a conductor and to reduce thermal energy convection. Blocking the thermal energy and the particulate matter can also help to protect the frame 54.

In this example, the busbar shields 100 can help to block and trap thermal energy and particulate matter that has passed through the agents 82 from contacting or being directly adjacent to the busbars 58 and other cells 38. In examples where the container assemblies 70 having the mixture of agents 82 are omitted from the battery pack 14, the busbar shields 100 can still help to block thermal energy and particulate matter from reaching the busbars 58.

In the exemplary embodiment, each of the busbar shields 100 each include three fingers 102 that are tapered. Other examples could have the busbar shields 100 with one or two fingers, or more than three fingers.

The busbar shields 100 can be ceramic wool, mica, fiberglass, or some combination of these. The busbar shields 100 can be partially compressed when installed.

The busbar shields 100 could be a sheet of material with apertures such as slots that permit tab terminals from the battery cells 38 to extend outboard to the busbars 58.

In the exemplary embodiment, the suppression devices container assemblies 70 are detached from the busbar shields 100. In other examples, the container assemblies 70 could be attached to the busbar shields 100 prior to installation within the enclosure assembly 46. The container assemblies 70 could be glued, heat staked, etc. to the busbar shields 100.

In some examples, the busbar shields 100 could be wrapped about the container assemblies 70 when inserted into the enclosure assembly 46 between the cells 38 and the busbars 58. After installation, the busbar shields 100 could unfold from the wrapped position into an installed position.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
an enclosure assembly that provides an interior area;
a plurality of battery cells disposed along a array axis and disposed within the interior area;
each of the plurality of battery cells including at least one tab terminal that projects outward from the array axis;
a frame providing at least one slot that receives a portion of the at least one tab terminal;
at least one busbar secured to the frame; and
a busbar shield between at least one cell and at least one busbar within a battery pack.

2. The battery pack assembly of claim 1, wherein the frame is between the at least one busbar and the busbar shield.

3. The battery pack assembly of claim 1, wherein the busbar shield is secured directly to the frame.

4. The battery pack assembly of claim 1, wherein the busbar shield includes a plurality of fingers.

5. The battery pack assembly of claim 4, wherein the plurality of fingers are a plurality of tapered fingers.

6. The battery pack assembly of claim 4, wherein the at least one tab terminal extends between the plurality of fingers.

7. The battery pack assembly of claim 1, wherein the busbar shield includes three fingers.

8. The battery pack assembly of claim 1, wherein the busbar shield is ceramic wool, mica, fiberglass, or some combination of these.

9. The battery pack assembly of claim 1, wherein the busbar shield is provided by a sheet of material having at least one shield slot, the at least one tab terminal extending through the shield slot.

10. The battery pack assembly of claim 1, wherein the at least one tab terminal is secured to the at least one busbar.

11. The battery pack assembly of claim 1, further comprising a container assembly that holds a mixture of agents, the container assembly configured to release the mixture of agents in response to a thermal event proximate the container assembly, the container assembly disposed between plurality of battery cells and the frame.

12. The battery pack assembly of claim 11, wherein the busbar shield is secured directly to the container assembly.

13. The battery pack assembly of claim 12, wherein the busbar shield is configured to wrap around the container assembly during installation of the container assembly within the battery pack.

14. The battery pack assembly of claim 11, wherein the busbar shield is between the container assembly and the frame.

15. The battery pack assembly of claim 11, wherein the agents are configured, when released from the container assembly, to electrically isolate, block a transfer of thermal energy, or both.

16. The battery pack assembly of claim 11, wherein the mixture of agents comprises sodium silicate.

17. An battery pack assembly, comprising:
an enclosure assembly that provides an interior area;
a plurality of battery cells disposed along a array axis and disposed within the interior area, each of the plurality of battery cells including at least one tab terminal that projects outward from the array axis;
a busbar module having a frame and a plurality of busbars mounted to the frame;
a plurality of container assemblies disposed alongside the plurality of battery cells between the busbar module and the plurality of battery cells, each holding a mixture of agents, the container assembly configured to release the mixture of agents in response to a thermal event proximate the container assembly, the plurality of container assemblies; and
one or more busbar shields disposed alongside the plurality of container assemblies between the busbar module and the plurality of battery cells, the at least one tab terminal extending between the plurality of container assembles, through a slot the busbar shield, and through a slot in the frame to connect to at least one of the busbars within the plurality of busbars.

18. The battery pack assembly of claim 17, wherein the busbar shields are between the plurality of container assemblies and the frame.

19. The battery pack assembly of claim 17, wherein the busbar shields are secured to the frame.
